(19) United States
(12) Patent Application Publication
(10) Pub. No.: US 2006/0289649 A1
(43) Pub. Date: Dec. 28, 2006

(54) Communication apparatus capable of communicating with data carrier and method of controlling communication between communication apparatus and data carrier

(75) Inventors: Akihiro Sugiura, Okazaki-shi (JP); Hiroshi Hishida, Kuwana-shi (JP); Tatsuya Hirata, Kariya-shi (JP)

Correspondence Address: POSZ LAW GROUP, PLC, 12040 SOUTH LAKES DRIVE, SUITE 101, RESTON, VA, 20191, US

(73) Assignee: DENSO WAVE INCORPORATED, Tokyo (JP)

(21) Appl. No.: 11/453,199

(22) Filed: Jun. 15, 2006

(30) Foreign Application Priority Data
Jun. 22, 2005 (JP) 2005-181998

(51) Int. Cl. G06K 7/08

(52) U.S. Cl. 235/451

(57) ABSTRACT

The communication apparatus capable of performing communication with at least one data carrier by means of electromagnetic waves includes a transmitting part configured to change a transmission power level of electromagnetic waves being transmitted from the communication apparatus depending on a level of a control signal supplied, and a control part producing the control signal. The control part is configured to gradually change the level of the control signal being supplied to the transmitting part when the transmission power level of the electromagnetic waves is needed to be changed.

### CROSS-REFERENCE TO RELATED APPLICATION

This application is related to Japanese Patent Application No. 2005-181998 filed on Jun. 22, 2005, the contents of which are hereby incorporated by reference.

### BACKGROUND OF THE INVENTION

1. Field of the Invention

The present invention relates to a communication apparatus capable of performing communication with a data carrier through electromagnetic coupling, and relates to a method of controlling communication between such a communication apparatus and a data carrier.

2. Description of Related Art

It is known to configure a card reader capable of communicating with a noncontact IC card, which is a kind of a data carrier, to transmit electromagnetic waves intermittently, or to reduce transmission power within specific time periods, for the purpose of reducing power consumption or avoiding communication interference in an environment where a plurality of card readers are disposed closely to one another. For example, Japanese Patent Application Laid-open No. 11-58186 discloses a technique for changing stepwise the power level of a transmission signal transmitted from a reader/writer to a noncontact IC card.

However, changing stepwise the power level of a transmission signal causes a problem that high frequency noise tends to occur. Accordingly, if the power level of a transmission signal is changed stepwise in an environment where other electronic devices are operating near the reader/writer, there occurs a possibility that these electronic devices are adversely affected. Furthermore, some types of such IC cards are configured to change, upon detecting that a received power has changed greatly, from a normal mode to a lock mode in which communication with the outside is disabled.

### SUMMARY OF THE INVENTION

The present invention provides a communication apparatus capable of performing communication with a data carrier through electromagnetic coupling, the communication apparatus comprising:

a transmitting part configured to change a transmission power level of electromagnetic waves being transmitted from the communication apparatus depending on a level of a control signal supplied; and

a control part producing the control signal;

wherein the control part is configured to gradually change the level of the control signal being supplied to the transmitting part when the transmission power level of the electromagnetic waves is needed to be changed.

The present invention also provides a method of controlling communication through electromagnetic coupling between a communication apparatus and a data carrier, the method comprising the steps of:

judging whether or not a transmission power level of electromagnetic waves being transmitted from the communication apparatus to the data carrier is needed to be changed; and

gradually changing the transmission power level when it is judged that the transmission power level is needed to be changed.

According to the present invention, since the transmission power of the electromagnetic waves emitted from the communication apparatus such as an IC card reader/writer to the data carrier such as an IC card can be changed gradually, it is possible to suppress occurrence of high frequency noise when the transmission power of the electromagnetic waves transmitted from the communication apparatus is changed, to thereby avoid other electronic devices operating near this communication apparatus from being adversely affected.

Other advantages and features will become apparent from the following description including the drawings and claims.

### BRIEF DESCRIPTION OF THE DRAWINGS

In the accompanying drawings:

FIG. 1 is a functional block diagram showing a structure of an IC card reader/writer as a communication apparatus according to a first embodiment of the invention;

FIG. 2A is a diagram showing a structure of a control signal output section included in the IC card reader/writer according to the first embodiment of the invention;

FIG. 2B is a diagram showing a structure of an output level changing circuit included in the control signal output section;

FIG. 2C is a diagram showing a structure of a variable resistor constituting an integrator circuit included in the control signal output section;

FIG. 2D is a diagram showing a structure of a variable capacitor constituting the integrator circuit included in the control signal output section;

FIG. 3 is a flowchart showing a control process performed by a CPU of the reader/writer according to the first embodiment of the invention;

FIGS. 4A to 4D are diagrams showing temporal change of a transmission power of electromagnetic waves transmitted from the reader/writer according to the first embodiment of the invention when the transmission power level is changed;

FIG. 5 is a functional block diagram showing a structure of an IC card reader/writer as a communication apparatus according to a second embodiment of the invention;

FIG. 6 is a flowchart showing a control process performed by a CPU of the reader/writer according to the second embodiment of the invention;

FIGS. 7A to 7D are diagrams showing temporal change of a transmission power of electromagnetic waves transmitted from the reader/writer according to the second embodiment of the invention when the transmission power level is changed;

FIG. 8 is a diagram showing how the envelope of electromagnetic waves transmitted from a reader/writer according to a third embodiment of the invention changes depending on a set transmission pattern;

FIG. 9 is a flowchart showing a time-constant setting process performed by a CPU of the reader/writer according to the third embodiment of the invention;

FIG. 10 is a diagram showing how the envelope of electromagnetic waves transmitted from a reader/writer according to a fourth embodiment of the invention changes depending on a set transmission pattern;

FIG. 11 is a flowchart showing a time-constant setting process performed by a CPU of the reader/writer according to the fourth embodiment of the invention;

FIG. 12 is a diagram showing how the envelope of electromagnetic waves transmitted from a reader/writer according to a fifth embodiment of the invention changes depending on a set transmission pattern;

FIG. 13 is a flowchart showing a time-constant setting process performed by a CPU of the reader/writer according to the fifth embodiment of the invention;

FIG. 14 is a functional block diagram showing a structure of an IC card reader/writer as a communication apparatus according to a sixth embodiment of the invention;

FIG. 15 is a diagram showing how the envelope of electromagnetic waves received by the reader/writer according to the sixth embodiment of the invention changes when an IC card approaches the reader/writer;

FIG. 16 is a flowchart showing a process performed by a CPU of the reader/writer according to the sixth embodiment of the invention for judging whether or not the transmission power level of electromagnetic waves can be changed; and

FIG. 17 is a flowchart showing a process performed by a CPU of a reader/writer according to a seventh embodiment of the invention for changing the transmission power level of electromagnetic waves depending on a result of IC card type detection.

### PREFERRED EMBODIMENTS OF THE INVENTION

First Embodiment

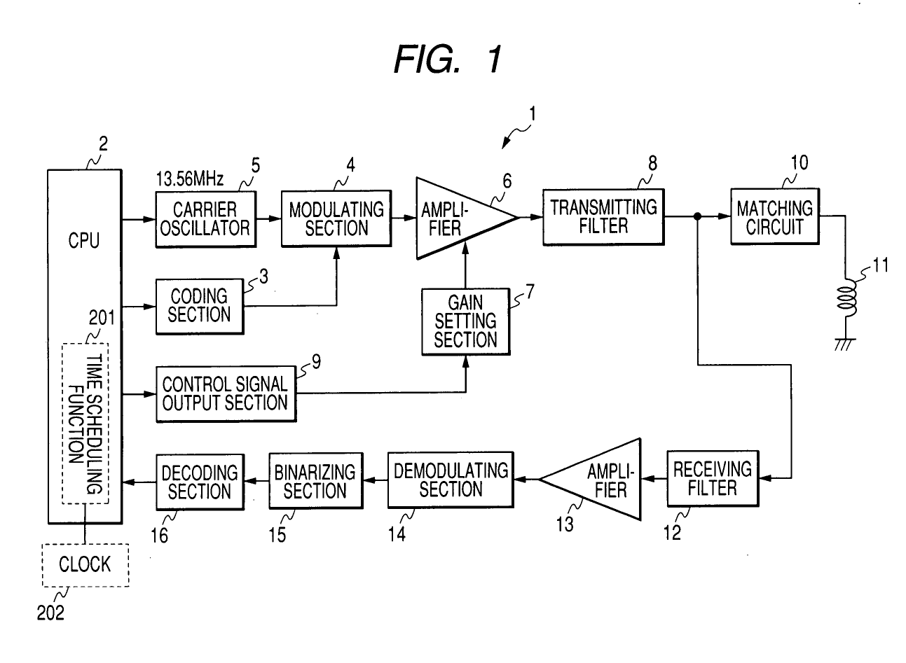

FIG. 1 is a functional block diagram showing a structure of a reader/writer 1 as a communication apparatus capable of performing communication with an IC card by means of electromagnetic waves according to a first embodiment of the invention. As shown in FIG. 1, the reader/writer 1 includes a CPU 2, a coding section 3, a modulating section 4, a carrier generator 5, an amplifier 6, a gain setting section 7, a transmitting filter 8, a control signal output section 9, a matching circuit 10, an antenna 11, a receiving filter 12, an amplifier 13, a demodulating section 14, a binarizing section 15, and a decoding section 16. The CPU 2 serves to control the entire operation of the reader/writer 1. The coding section 3 codes transmission data outputted from the CPU 2, and supplies it to the modulating section 4. The modulating section 4 performs ASK (Amplitude Shift Keying) modulation on a carrier having a constant frequency of 13.56 MHz, for example generated by the carrier oscillator 5 with the coded transmission data supplied from the coding section 3, to thereby produce a modulated signal. The modulated signal is supplied to the amplifier 6. The start/stop of the oscillating operation of the carrier generator 5 is controlled by the CPU 2.

The modulated signal produced by the modulating section 4 is amplified by the amplifier 6 by a gain set by the gain setting section 7, filtered by the transmitting filter 8, and then sent to the antenna 11 through the matching circuit 10 as a transmission signal. In consequence, the transmission signal is emitted in the form of electromagnetic waves to the outside from the antenna 11. The gain setting circuit 7 is configured to set the gain of the amplifier 6 in accordance with the voltage level of the control signal which the CPU 2 outputs through the control signal output section 9. A signal received by the antenna 11 is filtered by the receiving filter 12 connected to the antenna 11, amplified by the amplifier 13, and then demodulated by the demodulating section 14. The demodulated signal is binarized by the binarizing section 15, and then decoded by the decoding section 16. The decoded signal is supplied to the CPU 2 as received data.

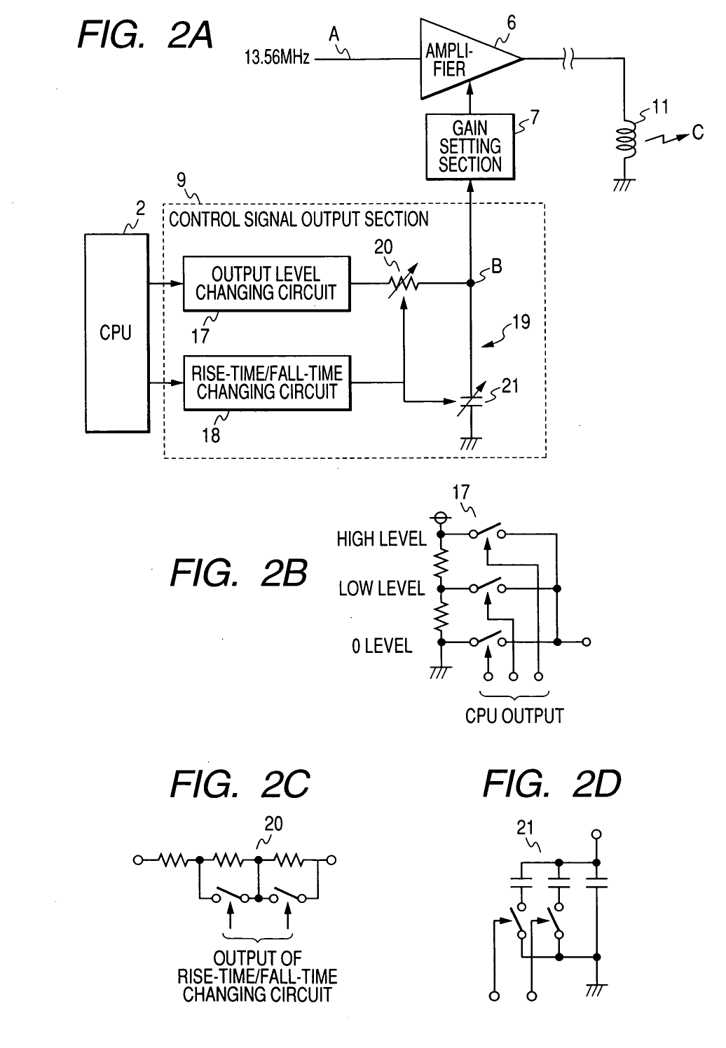

FIG. 2A is a diagram showing a structure of the control signal output section 9. As shown in this figure, the control signal output section 9 includes an output level changing circuit 17, a rise-time/fall-time changing circuit 18, and an integrator circuit 19. The integrator circuit 19 is constituted by a variable resistor 20 having a structure as shown in FIG. 2C, and a variable capacitor 21 having a structure as shown in FIG. 2D. An output terminal of the output level changing circuit 17 is connected to an input terminal of the integrator circuit 19. The rise-time/fall-time changing circuit 18 serves to set the resistance of the variable resistor 20 and the capacitance of the variable capacitor 21 at values specified by the CPU.

The level of the voltage outputted from the output level changing circuit 17 having a structure as shown in FIG. 2B to the integrator circuit 19 is specified by the CPU 2. The rise-time/fall-time changing circuit 18, which may be constituted by a data register, serves to set the time constant of the integrator circuit 19, which is defined by the resistance of the variable resistor 20 and the capacitance of the variable capacitor 21 in accordance with a data value written in the data register by the CPU 2. As understood from the above, the gain of the amplifier 6 set by the gain setting section 7, that is, the amplitude level or the transmission level of the electromagnetic waves emitted from the antenna 11 is determined by the output voltage of the output level changing circuit 17, and the rise time and fall time of the electromagnetic waves when the transmission level is changed is determined by the output voltage of the rise-time/fall-time changing circuit 18.

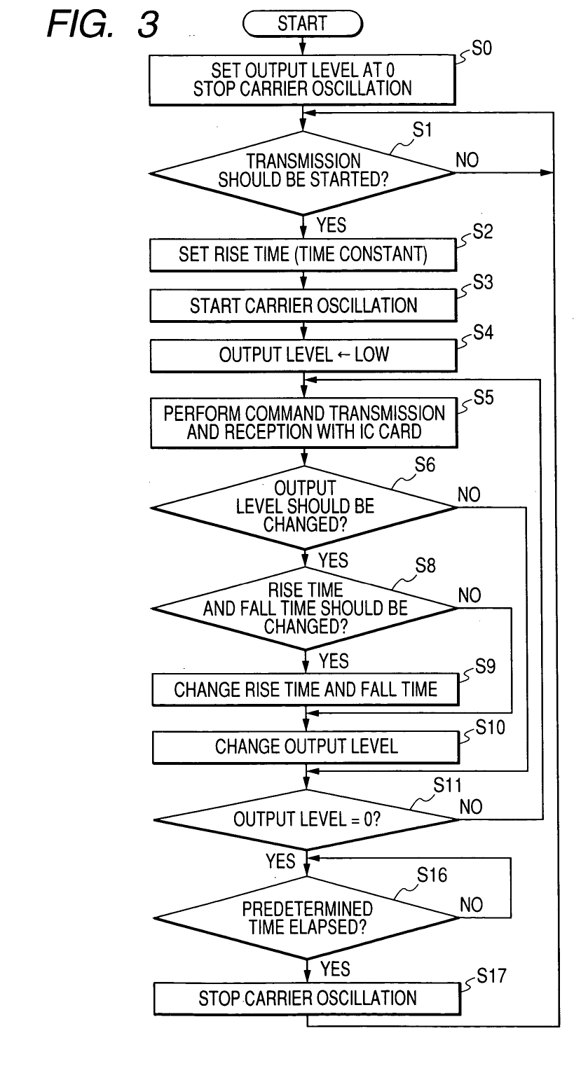

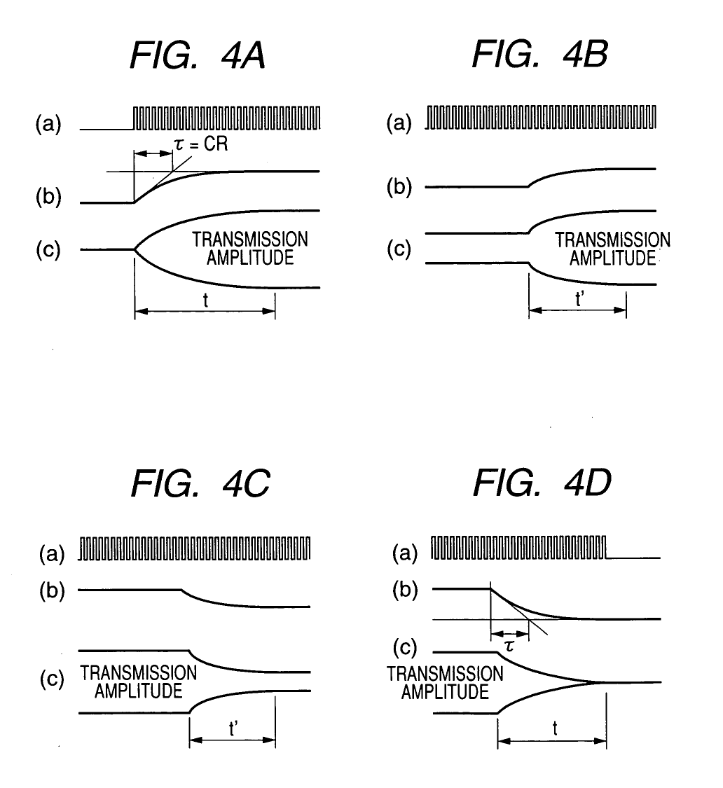

Next, the control process performed by the CPU 2 of the reader/writer 1 is explained with reference to a flowchart shown in FIG. 3. This control process begins by setting at step S0 the output level changing circuit 17 at an initial value of 0, and stopping the carrier oscillation. When a trigger event triggering transmission of electromagnetic waves (a user's manipulation of a transmission start switch, for example) occurs (YES in step S1), the CPU 2 writes, at step S2, setting data defining the rise time of the electromagnetic waves to be transmitted from the reader/writer 1 into the rise-time/fall-time changing circuit 18. Subsequently, the control process moves to step S3 where the carrier oscillation by the carrier oscillator 5 is started for the reader/writer 1 to be in a state of readiness for transmission (see (a) in FIG. 4A). After that, setting data of level “Low” is written into the output level changing circuit 17 to set the transmission power of the electromagnet waves at a low level, and then the transmission is started at step S4.

For the above operation, the CPU 2 causes the output level changing circuit 17 to output an analog voltage corresponding to the value of the setting data. At this time, the output voltage of the integrator circuit 19 increases gradually depending on the time constant τ set in the rise-time/fall-time changing circuit 18 (see (b) in FIG. 4A). Since the gain setting section 7 sets the gain of the amplifier 6 depending on the output voltage of the integrator circuit 19, the amplitude of the electromagnetic waves emitted from the antenna 11 increases gradually with the increase of the gain of the amplifier 6 (see (c) in FIG. 4A).

Thereafter, the control process moves to step S5 where the CPU 2 performs command transmission and reception with the IC card as necessary. After that, if it is determined that the level of the transmission power has to be changed due to occurrence of any trigger event (YES in step S6), the control process moves to step S8, otherwise moves to step S11. At step S8, it is checked whether or not it is necessary to change the rise time and the fall time at the time of changing the transmission power. If it is determined at step S8 that it is necessary to change the rise time and the fall time, the control process moves to step S9 where the setting data set in the rise-time/fall-time changing circuit 18 is changed, and then the control process moves to step S10. On the other hand, if it is determined at step S8 that it is not necessary to change the rise time and the fall time, the control process directly moves to step S10. At step S10, the transmission power is changed. Hence, when the transmission power of the electromagnetic waves is increased or reduced, or when the transmission is stopped, the transmission power changes gradually as shown in FIGS. 4B, 4C, or 4D. When the reader/writer 1 stops transmission of the electromagnetic waves (YES in step S11), the CPU 2 waits for a predetermined time necessary for the transmission power level to reach zero (waits for YES in step S16), and then causes the carrier oscillator 5 to stop the output of the carrier at step S17 (see (a) in FIG. 4D).

As explained above, in this embodiment, the CPU 2 controls the control signal output section 9 such that the value of the control signal supplied from the control signal output section 9 to the gain setting section 7 changes gradually, so that the transmission power of the electromagnetic waves emitted from the antenna 11 changes gradually depending on the value of the control signal. This makes it possible to suppress occurrence of high frequency noise when the transmission power of the electromagnetic waves transmitted from the reader-writer 1 is changed, to thereby avoid other electronic devices operating near this reader/writer 1 from being adversely affected.

Second Embodiment

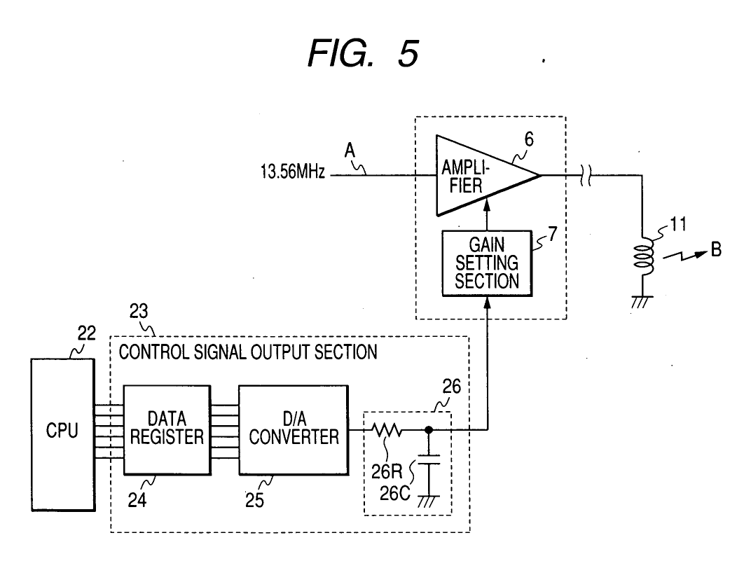

Next, a second embodiment of the invention is explained with reference to FIG. 5 to FIG. 7 which correspond to FIG. 2 to FIG. 4 showing the first embodiment. Here and in the following, identical reference characters will be used for the same or like components, and explanation thereof will be omitted. As shown in FIG. 5, in the second embodiment, the CPU 2 and the control signal output section 9 are replaced by a CPU 22 and a control signal output section 23, respectively. The control signal output section 23 includes a data register 24, a D/A converter 25, and an integrator circuit (low-pass filter) 26. The integrator circuit 26 is constituted by a resistor 26R having a fixed resistance and a capacitor 26C having a fixed capacitance.

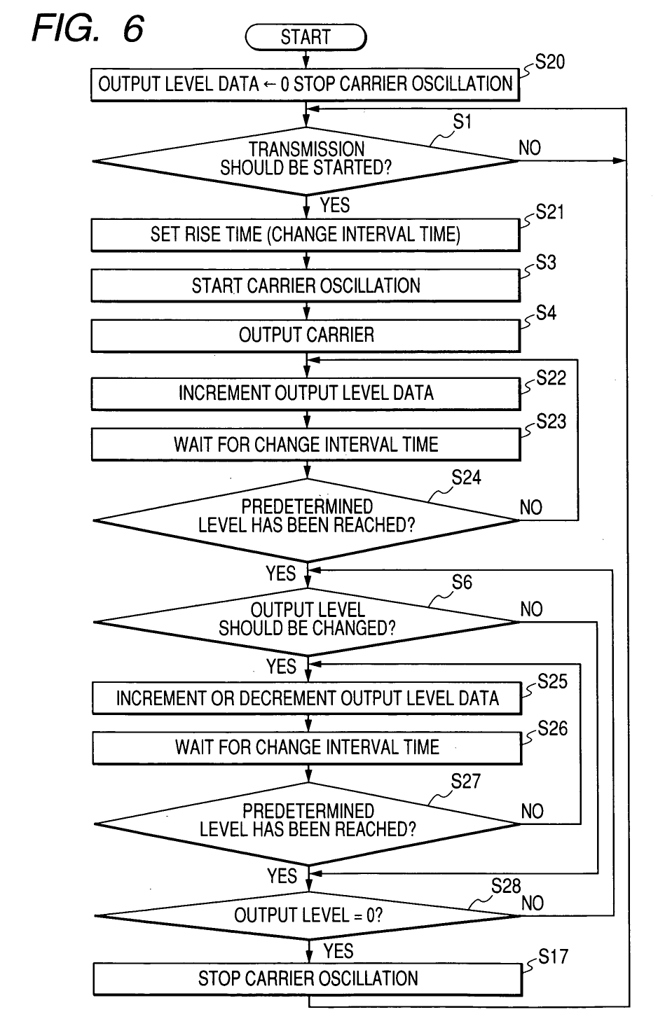

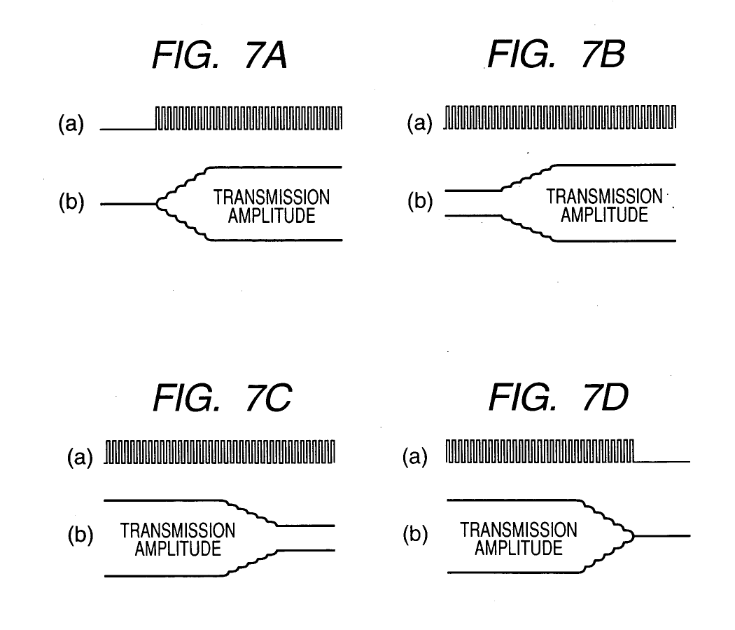

Next, the control process performed by the CPU 22 is explained with reference to a flowchart shown in FIG. 6. The steps S1, S3, S4, S6, and S17 in FIG. 6 are identical with those in FIG. 3. This control process begins by writing a value of 0 into the data register 24, and stopping the carrier oscillation at step S20 for initialization. After that, when the transmission is started (YES in step S1), a change interval time defining the value of the rise time is set at an initial value at step S21. Subsequently, the carrier oscillation is started at step S3, and the output of the carrier is started at step S4. Thereafter, the data value written in the data register 24 is incremented each time the change interval time set at step S21 is elapsed until it reaches a value corresponding to a predetermined initial transmission power level (step S22 to S24). At this time, the rise time is equal to the change interval time×the number of times that the increment has been performed. The level of the analog voltage signal supplied to the integrator circuit 26 through the D/A converter 25 increases smoothly with the incremental increase of the value of the data written in the data register 24. As a result, the amplitude or the transmission power of the electromagnetic waves increases gradually (see (b) in FIG. 7A).

When it is necessary to change the transmission power level (YES in step S6), the value of the data written in the data register 24 is incremented or decremented each time the change interval time is elapsed until it reaches a value corresponding to a target level (step S25 to step S27). As a result, the transmission power of the electromagnetic waves increases or decreases gradually (see (b) in FIG. 7B, or (b) in FIG. 7C). Likewise, when it is necessary to stop the transmission of the electromagnetic waves (YES in step S28), the value of the data written in the data register 24 is decremented to 0. As a result, the transmission power of the electromagnetic waves decreases accordingly (see (b) in FIG. 7D).

According to the second embodiment, since the control signal output section 23 is constituted by the data register 24, D/A converter 25, and integrator circuit 26, it is possible to digitally controls the transmission power, rise time, and fall time of the electromagnetic waves.

Third Embodiment

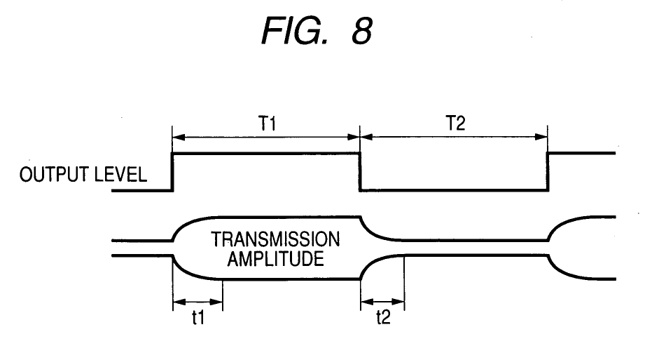

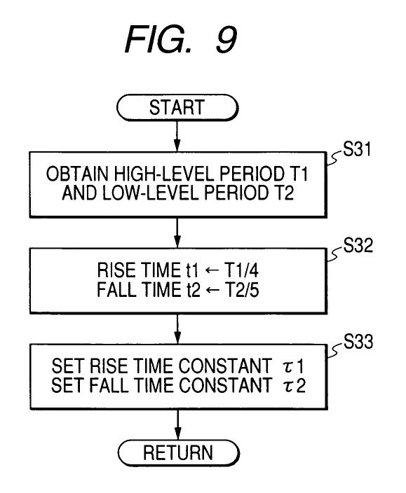

Next, a third embodiment of the invention is described. The third embodiment is the same as the first embodiment or the second embodiment in structure. However, in the third embodiment, the electromagnetic waves are transmitted in a specific transmission pattern. As shown in FIG. 8, the transmission pattern is a periodical repetition of a high-level period T1 (T1 also representing a length of the high-level period) in which the transmission power is set at a high level, and a low-level period T2 (T2 also representing a length of the low-level period) in which the transmission power is set at a low level. In the third embodiment, the CPU2 (or CPU 22) performs a time-constant setting process as shown in the flowchart of FIG. 9. This time-constant setting process begins by obtaining at step S31 the length of the high-level period T1 and the length of the low-level period T2, which are set by the user, for example. As subsequent step S32, the rise time t1 of the electromagnetic waves when the transmission power thereof is changed from the low level to the high level, and the fall time t2 of the electromagnetic waves when the transmission power thereof is changed from the high level to the low level are determined in accordance with the following expressions.
t1=T1/4, t2=T2/5

Finally, at step S33, the rise time-constant τ1 is set on the basis of the determined rise time t1, and the fall time-constant τ2 is set on the basis of the determined rise time t2.

To set the time constants τ1 and τ2 in the case of the reader/writer having the structure shown in FIG. 5, the change interval time at which the value of the data written in the data register 24 is incremented or decremented is adjusted. More specifically, to set the high-level period T1 and the low-level period T2 longer, the rise time t1 and the fall time t2 are set longer accordingly. Lengthening the rise time t1 and the fall time t2 does not cause shortage of electric power supplied to the IC card which makes it difficult to perform communication with the IC card, because when the rise time t1 and the fall time t2 are lengthened, a sufficiently long time over which the transmission power is kept stable can be secured within both the high-level period T1 and the low-level period T2.

As explained above, in the third embodiment, the CPU2 (or CPU 22) outputs the control signal through the control signal output section 9 (or 23) in order that the transmission power of the electromagnetic waves are changed periodically. And the rise time t1 of the electromagnetic waves when it is changed from the low level to the high level, and the fall time t2 of the electromagnetic waves when it is changed from the high level to the low level are set at appropriate values depending on the lengths of the high-level period T1 and the low-level period T2. Incidentally, during the high-level period T1, the reader/writer is in a condition in which it can reliably perform communication with the IC card. On the other hand, during the low-level period T2, the reader/writer does not actively perform communication with the IC card.

Fourth Embodiment

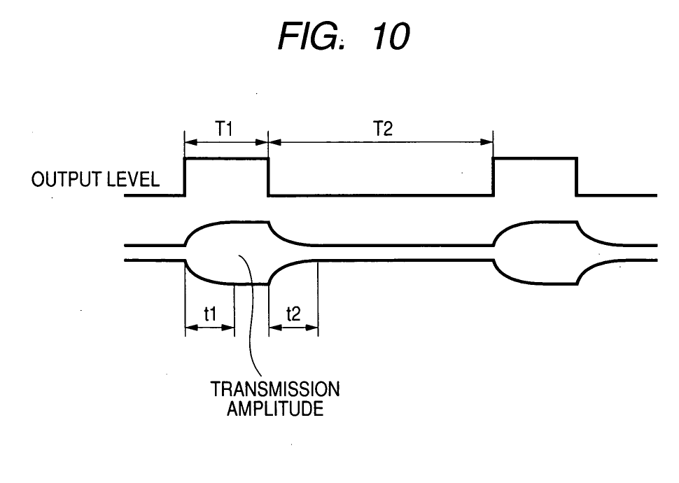

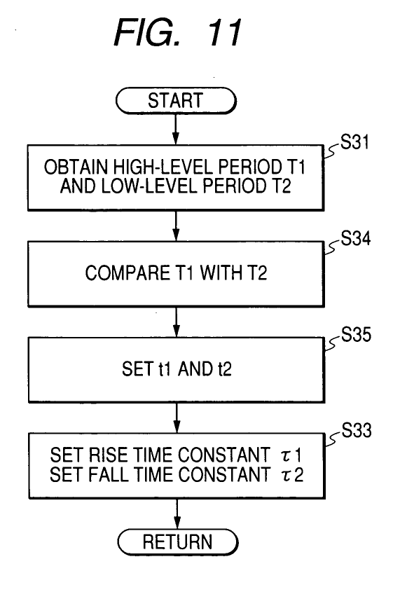

Next, a fourth embodiment of the invention is described. In the fourth embodiment, the electromagnetic waves are transmitted in a specific transmission pattern as in the case of the third embodiment. As shown in FIG. 10, in the fourth embodiment, the rise time t1 and the fall time t2 are set at the same value even when the length of the high-level period T1 is not equal to that of the low-level period T2. In the fourth embodiment, the CPU2 (or CPU 22) performs a time-constant setting process as shown in the flowchart of FIG. 11. This time-constant setting process begins by obtaining at step S31 the length of the high-level period T1 and the length of the low-level period T2. Next, they are compared with each other at step S34. At subsequent step S35, the rise time t1 and the fall time t2 are set at the same value depending on the length of the shorter one of the high-level period T1 and the low-level period T2. Finally, at step S33, the rise time-constant τ1 and the fall time-constant τ2 are set on the basis of this same value.

In the fourth embodiment, when both the high-level period T1 and the low-level period T2 are relatively long, the rise time t1 and the fall time t2 are set at the same relatively large value, as a result of which the level of the noise can be more reduced. On the other hand, when at least one of the high-level period T1 and the low-level period T2 is relatively short, the rise time t1 and the fall time t2 are set at the same relatively small value, as a result of which it becomes possible to avoid communication with the IC card from being interrupted due to shortage of electric power supplied to the IC card.

Fifth Embodiment.

Next, a fifth embodiment of the invention is described. Also in the fifth embodiment, the electromagnetic waves are transmitted in a specific transmission pattern as in the case of the third embodiment.

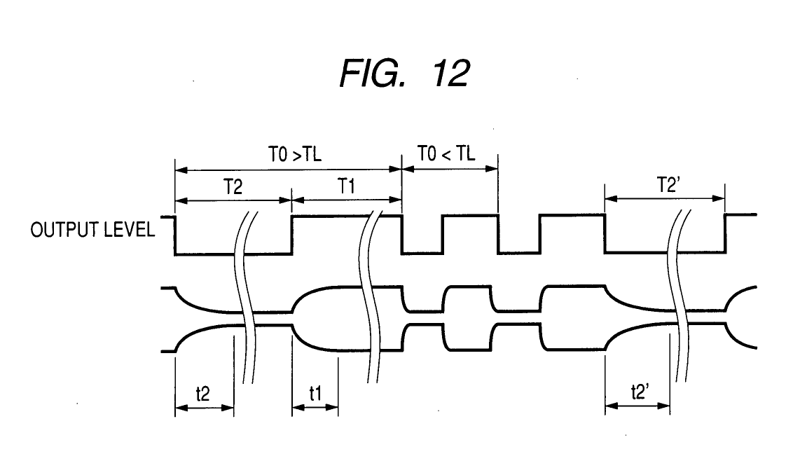

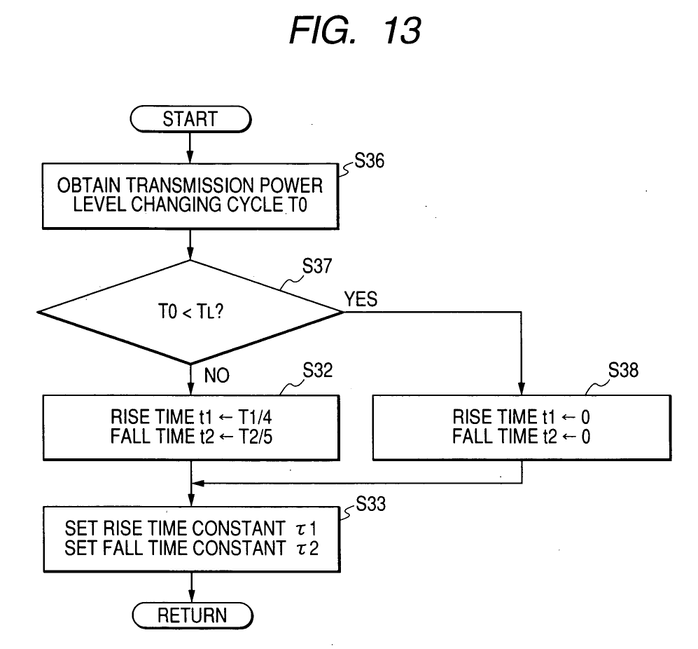

As shown in FIG. 12, in the fifth embodiment, the rise time t1 and the fall time t2 are set taking account of whether or not the transmission power level changing cycle TO (TO also represents the length of the transmission power level changing cycle) is longer than a predetermined threshold time TL. In the fifth embodiment, the CPU2 (or CPU 22) performs a time-constant setting process as shown in the flowchart of FIG. 13. This time-constant setting process begins by obtaining the length of the transmission power level changing cycle TO at step S36. At subsequent step S37, it is checked whether or not the transmission power level changing cycle TO is shorter than the threshold time TL. If it is determined that the transmission power level changing cycle TO is not shorter than the threshold time TL (NO in step S37), then steps 32 and step 33 as described in the third embodiment are performed. On the other hand, if it is determined that the transmission power level changing cycle TO is shorter than the threshold time TL (YES in step S37), then both the rise time t1 and the fall time t2 are set to 0 at step 38. After that, step S33 is performed.

In this embodiment, the threshold time TL is set at about 50 ms. The reason is that the timing cycle of a heart pacemaker is about 50 ms, and so if the transmission power level changing cycle TO is longer than 50 ms, such a heart pacemaker may be adversely affected when a person using such a pacemaker approaches the reader/writer. Accordingly in the case of TO>=TL, the CPU performs control to provide a time period over which the transmission power of the electromagnetic waves gradually increases or decreases to avoid the heart pacemaker from being adversely affected.

As explained above, according to the fifth embodiment which operates in the same way with the third embodiment when the transmission power level changing cycle TO is longer than the predetermined threshold time TL, it becomes possible to avoid electro-medical devices such as the heart pacemakers from being adversely affected by the noise emitted from the reader/writer. And when the transmission power level changing cycle TO is shorter than the predetermined threshold time TL, since there is no fear that the heart pacemakers are adversely affected, the rise time t1 and the fall time t2 are set at 0 in order to ensure a time period during which the communication with the IC card can be performed stably.

Sixth Embodiment

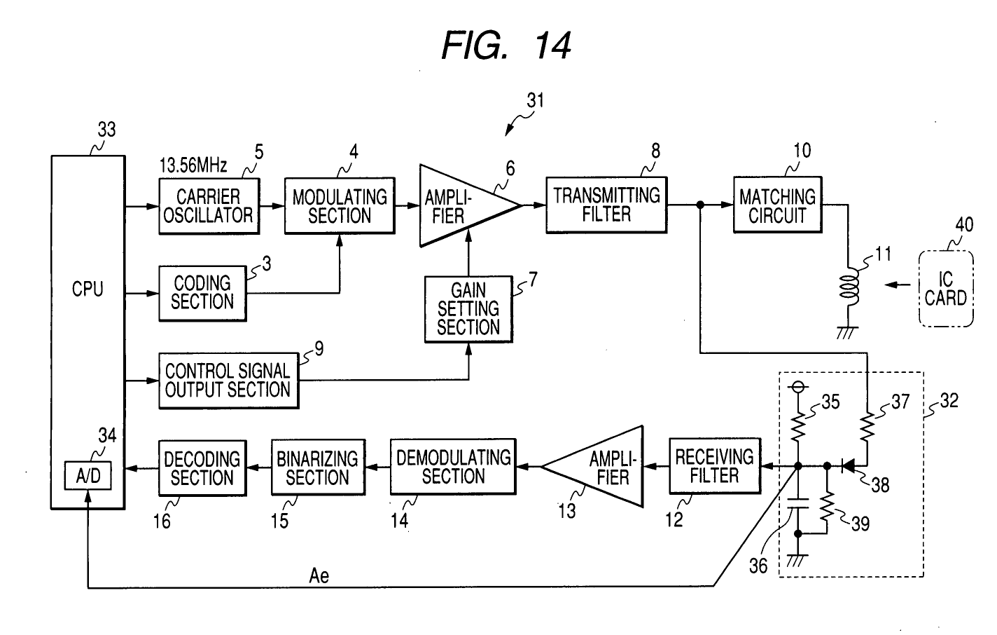

FIG. 14 is a functional block diagram showing a structure of a reader/writer 31 as a communication apparatus according to a sixth embodiment of the invention. The structure of the sixth embodiment is different from that of the first embodiment shown in FIG. 1 in that an envelope detector circuit 32 is additionally inserted between the transmitting filter 8 and the receiving filter 12, and the CPU 2 is replaced by a CPU 33 which includes therein an A/D converter 34. An envelope detection signal produced by the envelope detector circuit 32 is inputted to an analog signal input port (not shown) of the CPU 33 so that the CPU 33 can read the envelope detection signal converted into digital data by the A/D converter 34.

The envelope detector circuit 32 is constituted by a first series circuit of a resistor 35 and a capacitor 36 series-connected between a power supply and the ground, a second series circuit of a resistor 37 and a diode series-connected between the output terminal of the transmitting filter 8 and a common node of the first series circuit connected to the input terminal of the receiving filter 12, and a resistor parallel-connected to the capacitor 36.

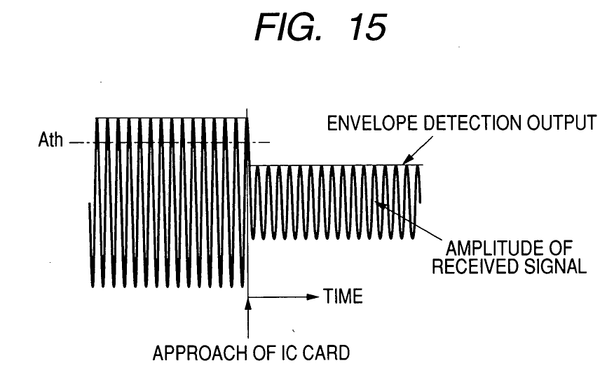

When the IC card (data carrier) 40 approaches the reader/writer 31, the input impedance of the reader/writer 31 changes, because the antenna 11 and an antenna included in the IC card 40 are magnetically coupled. As a result, the amplitude of a signal received by the antenna 11 changes greatly as shown in FIG. 15. Accordingly the CPU 33 can determine whether or not the IC card 40 is in the proximity of the reader/writer 31 on the basis of the amplitude level of the signal being received.

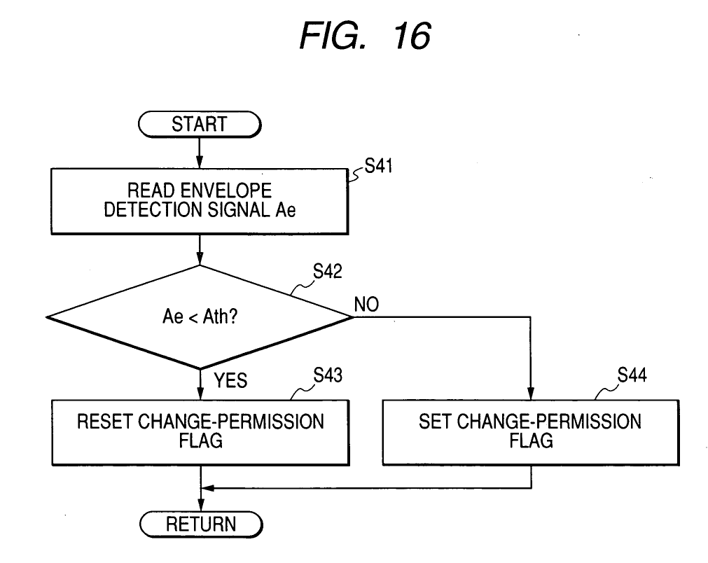

FIG. 16 is a flowchart for explaining a process performed by the CPU 33 for judging whether or not the transmission power level of the electromagnetic waves can be changed. This process begins by reading, through the A/D converter 34, the envelope detection signal Ae produced by the envelope detector circuit 32 at step S41. Subsequently, it is checked at step S42 whether or not the value of the envelope detection signal Ae is smaller than a predetermined threshold Ath. If it is determined that the value of the envelope detection signal Ae is smaller than the predetermined threshold Ath (YES in step S42), since it means that the IC card 40 is in the proximity of the reader/writer, a change-permission flag is reset at step S43. That is because, when the IC card 40 is in the proximity of the reader/writer, it is almost certain that the reader/writer performs communication with this IC card 40, and accordingly it is not necessary to change the transmission power of the electromagnetic waves being emitted from the antenna 11. On the other hand if it is determined that the value of the envelope detection signal Ae is not smaller than the predetermined threshold Ath (NO in step S42), since it means that the IC card 40 is not in the proximity of the reader/writer, the change-permission flag is set at step S44. The step S6 in the flowchart shown in FIG. 3 may be such that the transmission power level of the electromagnetic waves is determined to be changed only when the change-permission flag is in the reset state.

According to the sixth embodiment in which the CPU 33 resets the change-permission flag to keep the control signal constant when it is determined that the IC card is in the proximity in the reader/writer on the basis of the envelope detection signal produced by the envelope detector circuit 32, it becomes possible to prevent the transmission power level of the electromagnetic waves from being unnecessary changed to thereby avoid the noise from being emitted unnecessarily.

Seventh Embodiment

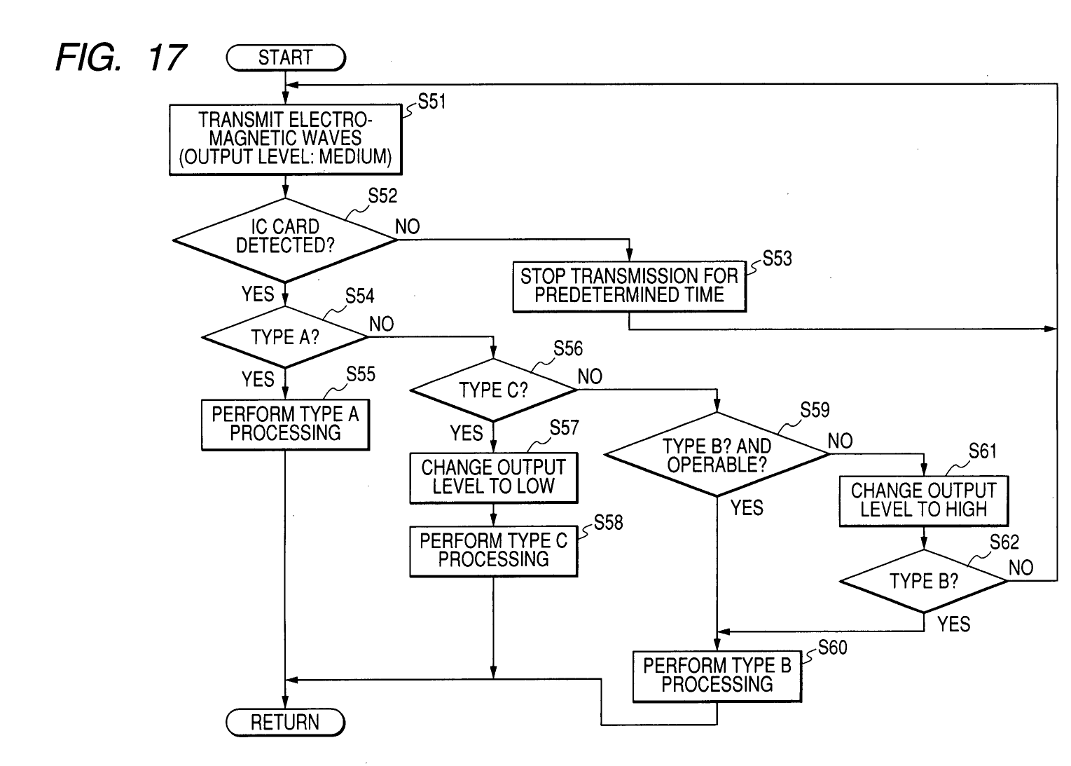

The seventh embodiment is different from the sixth embodiment in that, in the seventh embodiment, when an IC card is detected to be in the proximity of the reader/writer, the type of the IC card is also detected so that the communication with this IC card is performed while keeping the transmission power of the electromagnetic waves emitted from the antenna 11 at a level suitable for the type of this IC card. FIG. 17 is a flowchart explaining a communication process peculiar to the seventh embodiment. This communication process begins by setting the transmission power level of the electromagnetic waves at “medium” at step S51. Subsequently, it is checked at step S52 whether or not any IC card is in the proximity of the reader/writer. If any IC card is not detected (NO in step S52), the process moves to step S53 to stop transmission of the electromagnetic waves for a predetermined time period. After the lapse of the predetermined time period, the process returns to step S51.

On the other hand, if an IC card is detected (YES in step S52), the CPU 33 performs communication with this IC card to determine to which one of the type A, type B, and type C defined by IS014443 this IC card belongs (step S54, step S56, step S59). If the IC card is determined to belong to the type A (YES in step S54), since the “medium” is suitable for the type A, the process moves to step S55 to carry out communication according to the type A without changing the transmission power level of the electromagnetic waves. If the IC card is determined to belong to the type C (YES in step S56), the process moves to step S57 to change the transmission power level of the electromagnetic waves to “low”, and then moves to step S58 to carry out communication according to the type C. If it is determined that the IC card belongs to the type B and the communication with this type B IC card can be carried out at the transmission power level of “medium” (YES in step S59), then the process moves to step S60 to carry out communication according to the type B without changing the transmission power level of the electromagnetic waves. If it is determined that the IC card belongs to the type B but the communication with this type B IC card cannot be carried out at the transmission power level of “medium” (NO in step S59), then the process moves to step S61 to changer the transmission power level to “high”. After that, if is checked again at step S62 whether or not the IC card belongs to the type B. If the IC card is determined to belong to the type B, the process moves to step S60 to carry out communication according to the type B, otherwise the process returns to step S51.

As explained above, the seventh embodiment is configured such that, when the IC card is detected to be in the proximity of the reader/writer, if it is determined that the IC card is of the type B, and the communication with this type B IC card cannot be carried out at the transmission power level of “median”, the CPU 33 changes the transmission power level to “high”. Accordingly, with the seventh embodiment, the reliability of the communication between the reader/writer and the IC card can be improved.

It is a matter of course that various modifications can be made to the above described embodiment as described below. In the first embodiment, the integrator circuit 19 may be constituted by a resistor and a capacitor only one of which is variable. In the third embodiment, the expressions for determining the rise time t1 and the fall time t2 from the lengths of the high level period T1 and the low-level period T2 may be modified as necessary. In the third embodiment, the rise time t1 may be determined on the basis of the length of the low-level period T2, and the fall time t2 may be determined on the basis of the length of the high-level period T1. The third embodiment may be configured such that only one of the rise time t1 and the fall time t2 is determined on the basis of the length of the high-level period T1 and the length of the low-level period T2, and the other is fixed. The fourth embodiment may be configured such that only one of the rise time t1 and the fall time t2 is determined on the basis of the shorter one of the length of the high-level period T1 and the length of the low-level period T2, and the other is fixed.

In the sixth embodiment, instead of resetting the change-permission flag to inhibit the transmission power level of the electromagnetic waves from being changed, the length of the time intervals at which the value of the control signal supplied from the control signal output section 9 to the gain setting section 7 may be increased.

Furthermore, at least one of the rise time t1 and the fall time t2 may be set depending on the length of the power level changing cycle of repetition of the high-level period T1 and the low-level period T2. In the low-level period, the transmission power level of the electromagnetic waves may be set at 0 to disable the communication.

In a case where the CPU 2 has a time scheduling function by use of a real time clock (see dotted boxes 201, 202 in FIG. 1), the low-level period T2 may be set longer during nighttime hours in which the communication frequency is usually low, and the high-level period T1 may be set longer during daytime hours in which the communication frequency is usually high.

The number of levels of the transmission power of the electromagnetic waves is not limited to two (high level, and low level or 0 level). For example, the transmission power may be changed from one of three different levels to another level if the level change of the transmission power takes place gradually.

Although the above described embodiments are directed to a card reader/writer, the present invention is applicable to a card reader having only a reading function. The data carrier is not limited to an IC card. For example, it may be an RFID tag.

The above explained preferred embodiments are exemplary of the invention of the present application which is described solely by the claims appended below. It should be understood that modifications of the preferred embodiments may be made as would occur to one of skill in the art.

What is claimed is:

1. A communication apparatus capable of performing communication with at least one data carrier through electromagnetic coupling, said communication apparatus comprising:
a transmitting part configured to change a transmission power level of electromagnetic waves being transmitted from said communication apparatus depending on a level of a control signal supplied; and
a control part producing said control signal;
wherein said control part is configured to gradually change said level of said control 'signal being supplied to said transmitting part when said transmission power level of said electromagnetic waves is required to be changed.

2. The communication apparatus according to claim 1, wherein said control part is configured to produce said control signal in order that said transmission power level of said electromagnetic waves is changed cyclically between a high level and a low level, and that at least one of a rise time of said electromagnetic waves when said transmission power level is changed to said high level and a fall time of said electromagnetic waves when said transmission power level is changed to said low level depends on a length of a cycle of repetition of said high level and said low level.

3. The communication apparatus according to claim 1, wherein said control part is configured to produce said control signal in order that said transmission power level of said electromagnetic waves is changed cyclically between a high level and a low level, and that at least one of a rise time of said electromagnetic waves when said transmission power level is changed to said high level and a fall time of said electromagnetic waves when said transmission power level is changed to said low level depends on a length of one of a duration period of said high level and a duration period of said low level.

4. The communication apparatus according to claim 1, wherein said control part is configured to produce said control signal in order that said transmission power level of said electromagnetic waves is changed cyclically between a first level enabling communication with said data carrier and a second level disabling communication with said data carrier, and that at least one of a rise time of said electromagnetic waves when said transmission power level is changed to said first level and a fall time of said electromagnetic waves when said transmission power level is changed to said second level depends on a length of a cycle of repetition of said first level and said second level.

5. The communication apparatus according to claim 1, wherein said control part is configured to produce said control signal in order that said transmission power level of said electromagnetic waves is changed cyclically between a first level enabling communication with said data carrier and a second level disabling communication with said data carrier, and that at least one of a rise time of said electromagnetic waves when said transmission power level is changed to said first level and a fall time of said electromagnetic waves when said transmission power level is changed to said second level depends on a length of one of a duration period of said first level and a duration period of said second level.

6. The communication apparatus according to claim 5, wherein said rise time depends on said length of said duration period of said first level, and said fall time depends on said length of said duration period of said second level.

7. The communication apparatus according to claim 5, wherein said rise time depends on said length of said duration period of said second level, and said fall time depends on said length of said duration period of said first level.

8. The communication apparatus according to claim 5, wherein said rise time and said fall time depend on a length of shorter one of said duration period of said first level and said duration period of said second level.

9. The communication apparatus according to claim 4, wherein said rise time and said fall time are set substantially at 0 when a length of a cycle of repetition of said first level and said second level is shorter than a predetermined time.

10. The communication apparatus according to claim 5, wherein said control part includes a time scheduling function, and is configured to prolong a first time period over which said transmission power level is at said first level during a time zone in which frequency of communication with said data carrier is estimated high, and prolong a second time period over which said transmission power level is at said second level during a time zone in which frequency of communication with said data carrier is estimated low.

11. The communication apparatus according to claim 1, further comprising a detecting part detecting existence of any data carrier in the proximity of said communication apparatus, said control part being configured to keep said level of said control signal unchanged while said detecting part detects said existence.

12. The communication apparatus according to claim 1, further comprising a detecting part detecting existence of any data carrier in the proximity of said communication apparatus, said control part being configured to reduce a changing rate of said control signal when said detecting part detects said existence.

13. The communication apparatus according to claim 1, further comprising a detecting part detecting existence of any data carrier in the proximity of said communication apparatus, and a communication condition judging part judging whether or not communication with said data carrier can be carried at a current transmission power of said electromagnetic waves when said detecting part detects said existence, said control part being configured to increase said level of said control signal when said communication condition judging part judges that communication with said data carrier cannot be carried at said current transmission power of said electromagnetic waves.

14. A method of controlling communication through electromagnetic coupling between a communication apparatus and a data carrier, said method comprising the steps of:
judging whether or not a transmission power level of electromagnetic waves being transmitted from said communication apparatus to said data carrier is needed to be changed; and
gradually changing said transmission power level when it is judged that said transmission power level is needed to be changed.

15. The method according to claim 14, wherein said gradually changing step includes changing said transmission power level of said electromagnetic waves cyclically between a high level and a low level, while setting depending on a length of a cycle of repetition of said high level and said low level at least one of a rise time of said electromagnetic waves when said transmission power level is changed to said high level and a fall time of said electromagnetic waves when said transmission power level is changed to said low level.

16. The method according to claim 14, wherein said gradually changing step includes changing said transmission power level of said electromagnetic waves cyclically between a high level and a low level, while setting depending on a length of one of a duration period of said high level and a duration period of said low level at least one a rise time of said electromagnetic waves when said transmission power level is changed to said high level and a fall time of said electromagnetic waves when said transmission power level is changed to said low level.

17. The method according to claim 14, wherein said gradually changing step includes changing said transmission power level of said electromagnetic waves cyclically between a first level enabling communication between said control apparatus and said data carrier and a second level disabling communication between said control apparatus and said data carrier, while setting, depending on a length of a cycle of repetition of said first level and said second level, at least one of a rise time of said electromagnetic waves when said transmission power level is changed to said first level and a fall time of said of said electromagnetic waves when said transmission power level is changed to said second level.

18. The method according to claim 14, wherein said gradually changing step includes changing said transmission power level of said electromagnetic waves cyclically between a first level enabling communication between said communication apparatus and said data carrier and a second level disabling communication between said communication apparatus and said data carrier is enabled, while setting, depending on a length of one of a duration period of said first level and a duration period of said second level, at least one of a rise time of said electromagnetic waves when said transmission power level is changed to said first level and a fall time of said electromagnetic waves when said transmission power level is changed to said second level.

19. The method according to claim 18, wherein said rise time is set depending on said length of said duration period of said first level, and said fall time is set depending on said length of said duration period of said second level.

20. The method according to claim 18, wherein said rise time is set depending on said length of said duration period of said second level, and said fall time is set depending on said length of said duration period of said first level.

21. The method according to claim 18, wherein said rise time and said fall time are set depending on a length of shorter one of said duration period of said first level and said duration period of said second level.

22. The method according to claim 17, wherein said rise time and said fall time are set substantially at 0 when a length of a cycle of repetition of said first level and said second level is shorter than a predetermined time.

23. The method according to claim 18, wherein said gradually changing step includes prolonging a first time period over which said transmission power level is at said first level during a time zone in which frequency of communication between said communication apparatus and said data carrier is estimated high, and prolonging a second time period over which said transmission power level is at said second level during a time zone in which frequency of communication between said communication apparatus and said data carrier is estimated low.

24. The method according to claim 14, wherein said judging step includes detecting existence of any data carrier in the proximity of said communication apparatus, said gradually changing step includes keeping said transmission power level unchanged while said existence is detected.

25. The method according to claim 14, wherein said judging step includes detecting existence of any data carrier in the proximity of said communication apparatus, said gradually changing step includes reducing a changing rate of said transmission power level when said existence is detected.

26. The method according to claim 14, wherein said judging step includes detecting existence of any data carrier in the proximity of said communication apparatus, and judging whether or not communication between said communication apparatus and said data carrier can be carried at a current transmission power of said electromagnetic waves when said existence is detected, said gradually changing step includes increasing said transmission power level when it is judged that communication between said communication apparatus and said data carrier cannot be carried at said current transmission power of said electromagnetic waves.
